(19) United States
(12) Patent Application Publication
(10) Pub. No.: US 2019/0337488 A1
(43) Pub. Date: Nov. 7, 2019

(54) WINDSHIELD WIPER SYSTEM WITH SECTOR GEAR

(71) Applicant: Goodrich Corporation, Charlotte, NC (US)

(72) Inventors: Ashok Kumar Thirunarayana, Bangalore (IN); Adishesha Chinknyakanhalli Sivaramasastry, Bangalore (IN); Subhra Kanti Das, Bangalore (IN)

(21) Appl. No.: 16/164,222

(22) Filed: Oct. 18, 2018

(30) Foreign Application Priority Data
May 7, 2018 (IN) 201811017157

(51) Int. Cl. B60S 1/26; B60S 1/08; B60S 1/18

(52) U.S. Cl. CPC B60S 1/26; B60Y 2200/50; B60S 1/185; B60S 1/08

(57) ABSTRACT

A windshield wiper system (WWS) is provided. The WWS includes a wiper blade movable across a maximum sweep angle, a sector gear, a wiper arm coupled at opposite ends thereof to the wiper blade and the sector gear and a bi-directional motor. The bi-directional motor includes a motor shaft and a pinion gear disposed on the motor shaft to engage with the sector gear. The bi-directional motor is operable to drive rotations of the pinion and sector gears in opposite directions via the motor shaft to thereby drive opposite movements of the wiper blade via the wiper arm, respectively, without risking loss of engagement between the pinion and sector gears.

### CROSS-REFERENCE TO RELATED APPLICATIONS

This application claims the benefit of Indian Application No. 201811017157, filed May 7, 2018, which is incorporated herein by reference in its entirety.

### BACKGROUND

The following description relates to a windshield wiper system (WWS) of an aircraft and, more specifically, to a WWS of an aircraft with a sector gear.

A WWS of an aircraft is used for cleaning rain, sand, dust, etc. from a windshield. Generally, a WWS includes a wiper arm that needs to move in both clockwise and counter-clockwise directions to keep the windshield clean for the pilot/co-pilot to have good visibility. The wiper arm is typically moved by a shaft that is connected to a motor through gearing but there are various design configurations available and each has its own advantages and disadvantages.

In one WWS approach, the motor is controlled to spin bi-directionally and a four bar mechanism that might otherwise be needed can be eliminated. Here, one complete sweep from an inboard position to an outboard position (or vice versa) is accomplished by meshing between a gear and a pinion through 90°. Thus, while this system has a capability of meshing through 360° of the gear, only a portion of meshing is effectively utilized to generate the complete sweep of the wiper arm due to the bi-directional spin of the motor. Therefore, the system underutilizes its features, has increased weight, volume and bulk and has a characteristically low efficiency.

### BRIEF DESCRIPTION

According to an aspect of the disclosure, a windshield wiper system (WWS) is provided. The WWS includes a wiper blade movable across a maximum sweep angle, a sector gear, a wiper arm coupled at opposite ends thereof to the wiper blade and the sector gear and a bi-directional motor. The bi-directional motor includes a motor shaft and a pinion gear disposed on the motor shaft to engage with the sector gear. The bi-directional motor is operable to drive rotations of the pinion and sector gears in opposite directions via the motor shaft to thereby drive opposite movements of the wiper blade via the wiper arm, respectively, without risking loss of engagement between the pinion and sector gears.

In accordance with additional or alternative embodiments, the wiper blade is movably disposable to move across a windshield.

In accordance with additional or alternative embodiments, the sector gear is designed based on the maximum sweep angle.

In accordance with additional or alternative embodiments, the sector gear extends circumferentially along a slightly greater angle than the maximum sweep angle.

In accordance with additional or alternative embodiments, the sector gear includes a sector gear portion, a wiper shaft about which the sector gear portion is rotatable and a wiper shaft arm, to which the wiper arm is coupled, extending radially outwardly from the wiper shaft.

In accordance with additional or alternative embodiments, a closed-loop control system controls operations of the bi-directional motor.

In accordance with additional or alternative embodiments, the bi-directional motor is operable to indirectly drive forward and reverse movements of the wiper blade and to apply forward and reverse braking to the wiper blade.

In accordance with additional or alternative embodiments, mechanical stops prevent loss of engagement between the pinion and sector gears.

According to another aspect of the disclosure, a windshield wiper system (WWS) in which a wiper blade is movable across a maximum sweep angle of a windshield is provided. The WWS includes a sector gear, a bi-directional motor including a pinion gear disposed to engage with the sector gear, the bi-directional motor being operable to drive rotations of the pinion and sector gears in opposite directions to thereby drive opposite movements of the wiper blade, respectively, without risking loss of engagement between the pinion and sector gears, and a closed-loop control system to control operations of the bi-directional motor based on estimated sector gear positions.

In accordance with additional or alternative embodiments, the sector gear is designed based on the maximum sweep angle.

In accordance with additional or alternative embodiments, the sector gear extends circumferentially along a slightly greater angle than the maximum sweep angle.

In accordance with additional or alternative embodiments, the sector gear includes a sector gear portion, a wiper shaft about which the sector gear portion is rotatable and a wiper shaft arm, to which the wiper arm is coupled, extending radially outwardly from the wiper shaft.

In accordance with additional or alternative embodiments, the closed-loop control system includes sensors configured to sense a rotational condition of the bi-directional motor and a processing system configured to generate command signals for controlling the bi-directional motor in accordance with the rotational condition sensed by the sensors.

In accordance with additional or alternative embodiments, the bi-directional motor is operable to indirectly drive forward and reverse movements of the wiper blade and to apply forward and reverse braking to the wiper blade.

In accordance with additional or alternative embodiments, mechanical stops prevent loss of engagement between the pinion and sector gears

According to yet another aspect of the disclosure, a method of operating a windshield wiper system (WWS) in which a wiper blade is movable across a maximum sweep angle of a windshield is provided. The method includes engaging a pinion gear of a bi-directional motor with a sector gear, the sector gear having been designed based on the maximum sweep angle, sensing a rotational condition of the bi-directional motor and controlling the bi-directional motor to drive rotations of the pinion and sector gears in opposite directions in accordance with the sensed rotational condition to thereby drive opposite movements of the wiper blade, respectively, without risking loss of engagement between the pinion and sector gears.

In accordance with additional or alternative embodiments, the sector gear extends circumferentially along a slightly greater angle than the maximum sweep angle.

In accordance with additional or alternative embodiments, the controlling of the bi-directional motor includes indirectly driving forward and reverse movements of the wiper blade and applying forward and reverse braking to the wiper blade.

In accordance with additional or alternative embodiments, the controlling of the bi-directional motor includes indirectly driving forward movements of the wiper blade, applying forward braking to the wiper blade upon the sensed rotational condition indicating that the wiper blade reaches a forward pinion-sector gear contact boundary, indirectly driving reverse movements of the wiper blade and applying reverse braking to the wiper blade upon the sensed rotational condition indicating that the wiper blade reaches a reverse pinion-sector gear contact boundary.

In accordance with additional or alternative embodiments, the method further includes mechanically stopping the opposite movements of the wiper blade.

These and other advantages and features will become more apparent from the following description taken in conjunction with the drawings.

### BRIEF DESCRIPTION OF THE DRAWINGS

The subject matter, which is regarded as the disclosure, is particularly pointed out and distinctly claimed in the claims at the conclusion of the specification. The foregoing and other features and advantages of the disclosure are apparent from the following detailed description taken in conjunction with the accompanying drawings in which:

FIG. 1 is a perspective view of a windshield wiper system (WWS) in accordance with embodiments;

FIG. 2 is a schematic diagram of a closed-loop control system of the WWS of FIG. 1;

FIG. 3 is a graphical depiction of a control schedule of the closed-loop control system of FIG. 1; and

FIG. 4 is a schematic diagram of control circuitry of a bi-directional motor of the WWS of FIG. 1.

These and other advantages and features will become more apparent from the following description taken in conjunction with the drawings.

### DETAILED DESCRIPTION

As will be described below, a windshield wiper system (WWS) is disclosed that may provide for weight and volume reductions and improved efficiency. The WWS includes a sector gear that transmits mechanical power from a motor shaft to the wiper arm. The sector gear is designed such that it meets a wiper sweep angle requirement by having an optimum gear size and replaces a spur gear. The sector gear drives a wiper arm according to commands issued from a motor controller. The sector gear can slip out of contact with a pinion in case of improper positon control of a motor shaft. Hence, the tolerances are provided for the sector gear which are consistent with the positional control accuracy of the motor. This ensures a safety factor and serves to guarantee continuous contact of the sector gear with the pinion.

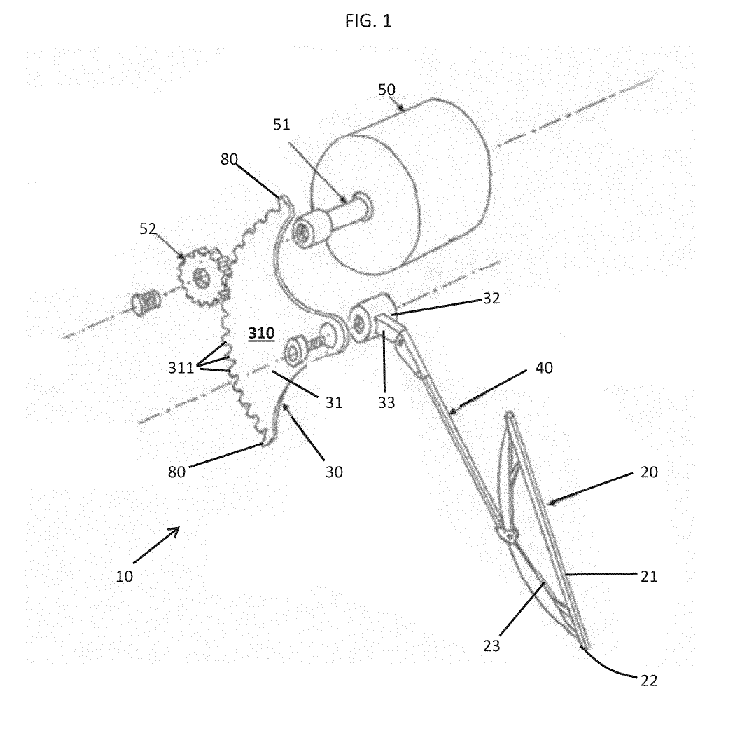

With reference to FIG. 1, a WWS 10 is provided and includes a wiper blade 20, a sector gear 30, a wiper arm 40, which is coupled at opposite ends thereof to the wiper blade 20 and the sector gear 30, and a bi-directional motor 50. The wiper blade 20 is movably disposable across a maximum sweep angle of a windshield of a ground-based or flight vehicle, such as an airplane or a helicopter. As the wiper blade 20 moves along the windshield in a first or forward direction, the wiper blade 20 removes water, dirt or other foreign debris from the surface of the windshield and, as the wiper blade 20 stops, reverses direction and then moves in the second or reverse direction, the wiper blade 20 removes additional water, dirt or other foreign debris that have collected since the previous pass. The illustrated wiper blade 20 includes a blade element 21 formed of compliant material, a blade element spine 22 to which the blade element 21 is affixed and which is capable of conforming to the surface of the windshield and an elastic element 23 that biases the blade element spine 22 toward increased contact with the windshield. The wiper arm 40 is coupled to the elastic element 23 by way of a hinge, a pin connection or another suitable connection such that relative rotation between the wiper arm 40 and the elastic element 23 is permitted.

In accordance with embodiments, the wiper blade 20 moves in the forward direction over a certain angular range (referred to herein as a “sweep angle”) and then moves in the reverse direction over the same angular range. A maximum sweep angle is the maximum sweep angle that the wiper blade 20 is designed to traverse in order to insure that the windshield can be cleared without the wiper blade 20 coming into contact with another wiper blade or a support structure of the windshield.

The sector gear 30 includes a sector gear portion 31, a wiper shaft 32 about which the sector gear portion 31 is rotatable and a wiper shaft arm 33 to which the wiper arm 40 is coupled by way of a hinge connection, a pin connection or another suitable connection such that relative rotation between the wiper arm 40 and the wiper shaft arm 33 is permitted. The wiper shaft arm 33 extends radially outwardly from the wiper shaft 32. With this configuration, as the sector gear portion 31 rotates about the wiper shaft 32 in a first or forward direction (e.g., a clockwise direction), the wiper shaft arm 33 drives a translation of the wiper arm 40, which, in turn, drives the forward movement of the wiper blade 20 along the windshield. As the sector gear portion 31 rotates about the wiper shaft 32 in a second or reverse direction (e.g., a counter-clockwise direction), the wiper shaft arm 33 drives a translation of the wiper arm 40, which, in turn, drives the reverse movement of the wiper blade 20 along the windshield.

The sector gear portion 31 includes a hub sector 310 and teeth 311 arranged along an exterior surface of the hub sector 310. Sidewalls of the hub sector 310 may be straight or curved inwardly, as shown in FIG. 1, to reduce a weight of the sector gear portion 31 and an overall weight of the WWS 10. The sector gear portion 31 may be designed based on the maximum sweep angle of the wiper blade 20 and, in particular, may be designed to extend circumferentially along a slightly greater angle than the maximum sweep angle of the wiper blade 20.

The bi-directional motor 50 includes a motor shaft 51 and a pinion gear 52. The pinion gear 52 is disposable on the motor shaft 51 and has teeth configured to engage with the teeth 311 of the sector gear portion 31. The bi-directional motor 50 is operable to drive rotations of the pinion gear 52 and the sector gear 31 in first and second opposite directions via the motor shaft 51 (e.g., the clockwise and counter-clockwise directions) to thereby drive opposite movements of the wiper blade 20 via the wiper arm 40, respectively, without risking loss of engagement between the pinion gear 52 and the sector gear 31.

In accordance with embodiments, the sector gear portion 31 may be designed as follows. Where a sweep angle of the wiper blade 20 (in degrees) is X, a corresponding sweep angle at the motor shaft 51 (with a gear ratio of, e.g., 1:70) is X *70 and a number of rotations of the motor shaft 51 is X*70/360. If one assumes a positional accuracy of the motor shaft 51 (in degrees) of 15° and a positional accuracy at the wiper arm 40 (in degrees) of 0.21° (15°/70) and a sector angle (in degrees) of X ±5°, the maximum sweep angle required in the WWS 10 is about 90° in order for the wiper blade 20 to sweep the windshield sufficiently. Hence, the sector gear portion 31 may be designed with a circumference of 100° to insure that the sector gear portion 31 does not decouple from the pinion gear 52 without adding unnecessary weight. A diameter D of the sector gear portion 31 may be established based on a torque required at the wiper blade 20 and the manufacturing of the sector gear portion 31 is executed with consideration given to material stresses and strengths.

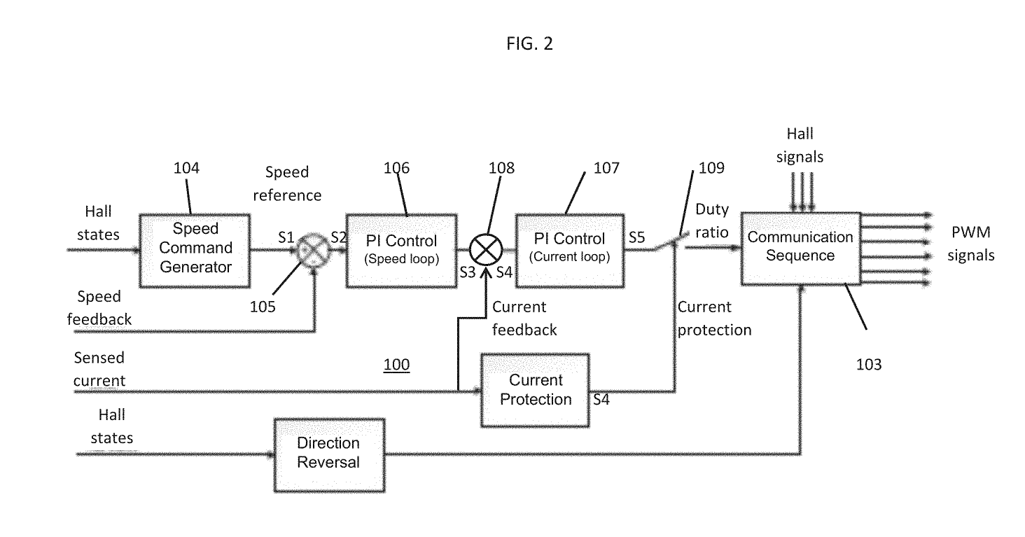

With reference to FIGS. 2-4, the WWS 10 may further include a closed-loop control system 100 to control operations of the bi-directional motor 50.

As the use of sector gear 30 represents an inertial reduction from a full spur gear, the closed-loop control system 100 is configured to fine-tune speed and current loop gains to encourage relatively smooth wiper drive operations. In particular, the closed-loop control system 100 is configured to control speed and torque of the bi-directional motor 50 based on the speed and current loop gains, which may be selected dynamically, to achieve adaptive motor control. Such adaptive motor control can be executed, for example, to prevent the sector gear 30 from moving out of contact with the pinion gear 52. The adaptive motor control is thus designed to ensure continuous engagement between the sector gear 30 and the pinion gear 52.

The closed-loop control system 100 may include wiring 101 (see FIG. 4) that can be energized according to a commutation sequence to drive rotations of the bi-directional motor 50, one or more sensors 102 (see FIG. 4), such as Hall effect sensors, which are distributed around the bi-directional motor 50 and a commutation sequence unit 103 that generates the commutation sequence as pulse width modulation signals (PWM signals) in accordance with a rotational condition of the bi-directional motor 50 as sensed by the sensors 102 and in accordance with duty ratio commands and a direction reversal command that are generated by additional features of the closed-loop control system 100.

As shown in FIGS. 2 and 4, the additional features of the closed-loop control system 100 may include a speed command generator unit 104, a first summation unit 105, first and second proportional integral (PI) control units 106 and 107, a second summation unit 108 and a switching element 109. The speed command generator unit 104 receives sensing results from the sensors 102, e.g., Hall states from the Hall effect sensors (see FIG. 4), and outputs a speed reference signal 51 to the summation unit 105. The speed reference signal 51 is combined with a speed feedback signal in the summation unit 105, which outputs a combined signal S2 to the first PI control unit 106. The first PI control unit 106 acts as a speed loop control element and outputs a third signal S3 to the second summation unit 108 in which the third signal S3 is combined with a current feedback signal to generate a fourth signal S4. The fourth signal S4 is output to the second PI control unit 107. The second PI control unit 107 acts as a current loop element and outputs duty ratio commands as a fifth signal S5 to the commutation sequence unit 103 via the switching element 109. The switching element 109 can either be closed whereby the commutation sequence unit 103 receives the fifth signal S5 or opened by a current protection signal. The current protection signal acts as a safety feature that can effectively de-energize the wiring 101 in an event the wiper blade 20 reaches its sweep end-point.

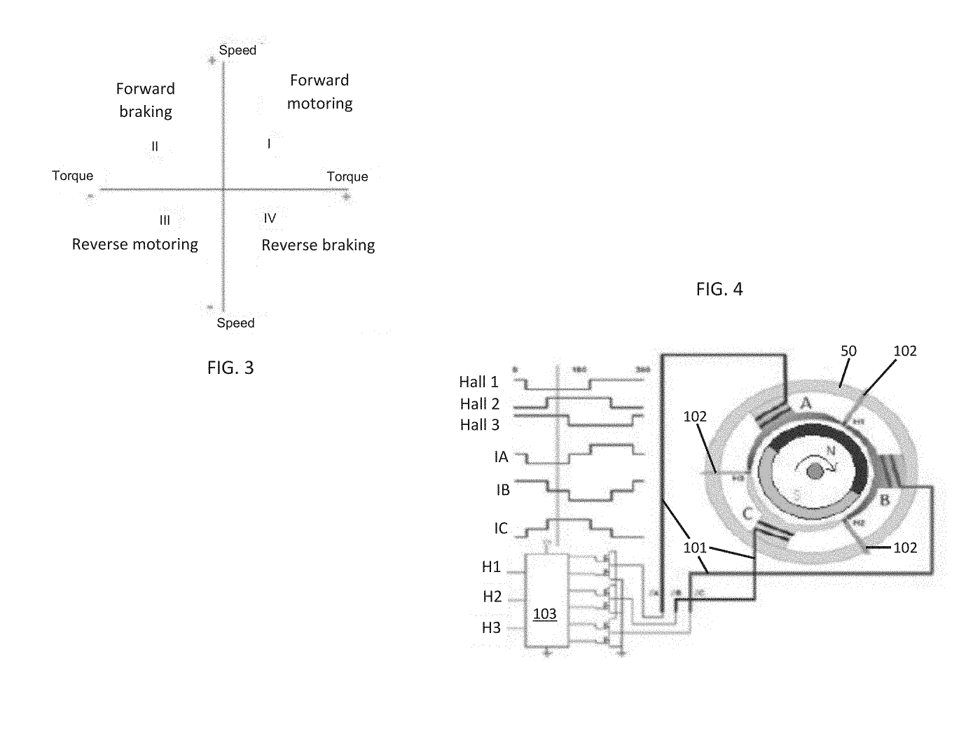

That is, in an operation of the WWS 10 and the closed-loop control system 100, the closed-loop control system 100 energizes the wiring 101 to drive forward rotation of the bi-directional motor 50 and a corresponding forward movement of the wiper blade 20 (see FIG. 3). A current rotational position of the sector gear 30 is estimated from sensing results of the sensors 102 and, in an event that the sector gear 30 reaches its boundary of contact with the pinion gear 52, the closed-loop control system 100 effectively applies an electromagnetic brake in the bi-directional motor 50 (e.g., forward braking) that stops the forward movement of the wiper blade 20 (see FIG. 3). The closed-loop control system 100 then energizes the wiring 101 to drive reverse rotation of the bi-directional motor 50 and a corresponding reverse movement of the wiper blade 20 (see FIG. 3). A current rotational position of the sector gear 30 is again estimated from sensing results of the sensors 102 and, in an event that the sector gear 30 reaches its boundary of contact with the pinion gear 52, the closed-loop control system 100 effectively applies an electromagnetic brake in the bi-directional motor 50 (e.g., reverse braking) that stops the reverse movement of the wiper blade 20 (see FIG. 3).

In accordance with embodiments and, with reference back to FIG. 1, the WWS 10 may further include mechanical stop features 80 that serve to mechanically prevent the sector gear 30 from rotating being the point where the sector gear 30 becomes decoupled from the pinion gear 52. As shown in FIG. 1, the mechanical stop features 80 may include or be provided as end teeth, which are bigger and of a different shape than the other teeth 311 of the sector gear portion 31 and which are configured to prevent further rotation of either the sector gear 30 or the pinion gear 52 once they engage with the pinion gear 52. The mechanical stop features 80 may also include or be provided as mechanical stoppers that interfere with rotations of the sector gear 30 beyond certain points.

Benefits of the features described herein are an optimized design of the sector gear 30 to reduce weight and volume by up to about 30%, to reduce costs and to improve overall efficiency of the WWS 10. The WWS 10 is capable of meeting design requirements of various vehicles including, but not limited to, low-medium torque helicopters and high torque aircraft.

While the disclosure is provided in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that the exemplary embodiment(s) may include only some of the described exemplary aspects. Accordingly, the disclosure is not to be seen as limited by the foregoing description, but is only limited by the scope of the appended claims.

What is claimed is:

1. A windshield wiper system (WWS), comprising:
a wiper blade movable across a maximum sweep angle;
a sector gear;
a wiper arm coupled at opposite ends thereof to the wiper blade and the sector gear; and
a bi-directional motor including a motor shaft and a pinion gear disposed on the motor shaft to engage with the sector gear,
the bi-directional motor being operable to drive rotations of the pinion and sector gears in opposite directions via the motor shaft to thereby drive opposite movements of the wiper blade via the wiper arm, respectively, without risking loss of engagement between the pinion and sector gears.

2. The WWS according to claim 1, wherein the wiper blade is movably disposable to move across a windshield.

3. The WWS according to claim 1, wherein the sector gear is designed based on the maximum sweep angle.

4. The WWS according to claim 1, wherein the sector gear extends circumferentially along a slightly greater angle than the maximum sweep angle.

5. The WWS according to claim 1, wherein the sector gear comprises:
a sector gear portion;
a wiper shaft about which the sector gear portion is rotatable; and
a wiper shaft arm, to which the wiper arm is coupled, extending radially outwardly from the wiper shaft.

6. The WWS according to claim 1, further comprising a closed-loop control system to control operations of the bi-directional motor.

7. The WWS according to claim 1, wherein the bi-directional motor is operable to indirectly drive forward and reverse movements of the wiper blade and to apply forward and reverse braking to the wiper blade.

8. The WWS according to claim 1, further comprising mechanical stops to prevent loss of engagement between the pinion and sector gears.

9. A windshield wiper system (WWS) in which a wiper blade is movable across a maximum sweep angle of a windshield, the WWS comprising:
a sector gear;
a bi-directional motor including a pinion gear disposed to engage with the sector gear,
the bi-directional motor being operable to drive rotations of the pinion and sector gears in opposite directions to thereby drive opposite movements of the wiper blade, respectively, without risking loss of engagement between the pinion and sector gears; and
a closed-loop control system to control operations of the bi-directional motor based on estimated sector gear positions.

10. The WWS according to claim 9, wherein the sector gear is designed based on the maximum sweep angle.

11. The WWS according to claim 9, wherein the sector gear extends circumferentially along a slightly greater angle than the maximum sweep angle.

12. The WWS according to claim 9, wherein the sector gear comprises:
a sector gear portion;
a wiper shaft about which the sector gear portion is rotatable; and
a wiper shaft arm, to which the wiper arm is coupled, extending radially outwardly from the wiper shaft.

13. The WWS according to claim 9, wherein the closed-loop control system comprises:
sensors configured to sense a rotational condition of the bi-directional motor; and
a processing system configured to generate command signals for controlling the bi-directional motor in accordance with the rotational condition sensed by the sensors.

14. The WWS according to claim 9, wherein the bi-directional motor is operable to indirectly drive forward and reverse movements of the wiper blade and to apply forward and reverse braking to the wiper blade.

15. The WWS according to claim 9, further comprising mechanical stops to prevent loss of engagement between the pinion and sector gears.

16. A method of operating a windshield wiper system (WWS) in which a wiper blade is movable across a maximum sweep angle of a windshield, the method comprising:
engaging a pinion gear of a bi-directional motor with a sector gear, the sector gear having been designed based on the maximum sweep angle;
sensing a rotational condition of the bi-directional motor; and
controlling the bi-directional motor to drive rotations of the pinion and sector gears in opposite directions in accordance with the sensed rotational condition to thereby drive opposite movements of the wiper blade, respectively, without risking loss of engagement between the pinion and sector gears.

17. The method according to claim 16, wherein the sector gear extends circumferentially along a slightly greater angle than the maximum sweep angle.

18. The method according to claim 16, wherein the controlling of the bi-directional motor comprises indirectly driving forward and reverse movements of the wiper blade and applying forward and reverse braking to the wiper blade.

19. The method according to claim 16, wherein the controlling of the bi-directional motor comprises:
indirectly driving forward movements of the wiper blade;
applying forward braking to the wiper blade upon the sensed rotational condition indicating that the wiper blade reaches a forward pinion-sector gear contact boundary;
indirectly driving reverse movements of the wiper blade; and
applying reverse braking to the wiper blade upon the sensed rotational condition indicating that the wiper blade reaches a reverse pinion-sector gear contact boundary.

20. The method according to claim 16, further comprising mechanically stopping the opposite movements of the wiper blade.
